(19) United States
(12) Patent Application Publication
(10) Pub. No.: US 2026/0118955 A1
(43) Pub. Date: Apr. 30, 2026

(54) ELECTRONIC DEVICE, CONTROL METHOD THEREFOR, AND STORAGE MEDIUM

(71) Applicant: CANON KABUSHIKI KAISHA, Tokyo (JP)

(72) Inventor: ATSUSHI SUGITA, Kanagawa (JP)

(21) Appl. No.: 19/368,912

(22) Filed: Oct. 24, 2025

(30) Foreign Application Priority Data
Oct. 30, 2024 (JP) 2024-190707

(51) Int. Cl. G06F 3/01

(52) U.S. Cl. CPC G06F 3/013

(57) ABSTRACT

An electronic device includes a first detection unit configured to detect a line of sight of a left eye of a user who looks at a first display unit, a second detection unit configured to detect a line of sight of a right eye of the user who looks at a second display unit, at least one memory storing a program, and at least one processor that, upon execution of the stored program, is configured to, in a case where a predetermined condition is satisfied, perform control to change any one of the first detection unit or the second detection unit from a first state to a second state that results in lower power consumption than the first state.

### BACKGROUND

### Field of the Technology

The present disclosure relates to an electronic device, a control method therefor, and a storage medium.

### Description of the Related Art

Recently, electronic devices using line-of-sight information about the user as a user interface have been used in various fields, and examples of the electronic devices include a head-mounted display (HMD). Some HMDs are capable of using virtual reality (VR) or augmented reality (AR).

Specifically, in a case where the user wears the HMD and then uses content for VR, the user is able to have an experience in a virtual space (VR space), in which, for example, a virtual object is displayed, as if the user has entered the virtual space. Moreover, in a case where the user wears the HMD and then uses content for AR, the user is able to add digital content that does not exist in reality (for example, a subject such as a character) to a real space (AR space) and thus to have an experience as if the user feels that a thing that does not exist in a real world exists.

Japanese Patent Laid-Open No. 2024-109785 describes a head-mounted display in which two line-of-sight tracking devices for monitoring the respective line-of-sight directions of the user's left and right eyes are arranged.

The user can use the head-mounted display described in Japanese Patent Laid-Open No. 2024-109785 and select a virtual object in the VR space or a subject in the AR space based on the respective line-of-sight directions of the user's left and right eyes. In this case, because the two line-of-sight tracking devices are used to monitor the respective line-of-sight directions of the user's left and right eyes, the head-mounted display consumes a large amount of electric power.

### SUMMARY

The present disclosure is directed to reducing power consumption of an electronic device while performing line-of-sight detection for a user.

According to an aspect of the present disclosure, an electronic device includes a first detection unit configured to detect a line of sight of a left eye of a user who looks at a first display unit, a second detection unit configured to detect a line of sight of a right eye of the user who looks at a second display unit, at least one memory storing a program, and at least one processor that, upon execution of the stored program, is configured to, in a case where a predetermined condition is satisfied, perform control to change any one of the first detection unit or the second detection unit from a first state to a second state that results in lower power consumption than the first state.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views illustrating an example of an appearance of a head-mounted display (HMD) according to a first embodiment.

FIG. 2 is a block diagram illustrating an example of a configuration of the HMD according to the first embodiment.

FIG. 3 is a diagram illustrating principles of line-of-sight detection.

FIG. 4A is a schematic diagram of an eyeball image that a light-receiving lens forms, and FIG. 4B is a schematic diagram of a luminance distribution in an area a illustrated in FIG. 4A.

FIG. 5 is a flowchart concerning line-of-sight detection processing according to the first embodiment.

FIGS. 6A and 6B are diagrams illustrating a method of calculating a line-of-sight position obtained when a user looks at a subject with both eyes, according to the first embodiment.

FIG. 7 is a flowchart concerning mode switching processing according to the first embodiment.

FIGS. 8A and 8B are diagrams illustrating timings at which to perform predetermined processing operations based on lines of sight in the respective modes, according to the first embodiment.

FIGS. 9A and 9B are flowcharts concerning mode switching processing according to a second embodiment.

### DESCRIPTION OF THE EMBODIMENTS

Various embodiments, features, and aspects of the present disclosure will be described in detail below with reference to the drawings. In the following embodiments, a head-mounted display (HMD) is described as an example of an electronic device that performs line-of-sight detection. A video image that the user is looking at through the HMD is referred to as an “external video image (three-dimensional (3D) space)”. A case where, when capturing an external video image including a subject with use of an image capturing device included in the HMD, the HMD selects the subject based on the line of sight of the user is described as an example. However, the present disclosure can also be applied to, for example, a case where, when worn on the head of the user, the HMD selects a virtual object in a virtual reality (VR) space based on the line of sight of the user or a case where, when worn on the head of the user, the HMD selects a subject in an augmented reality (AR) space based on the line of sight of the user.

### First Embodiment

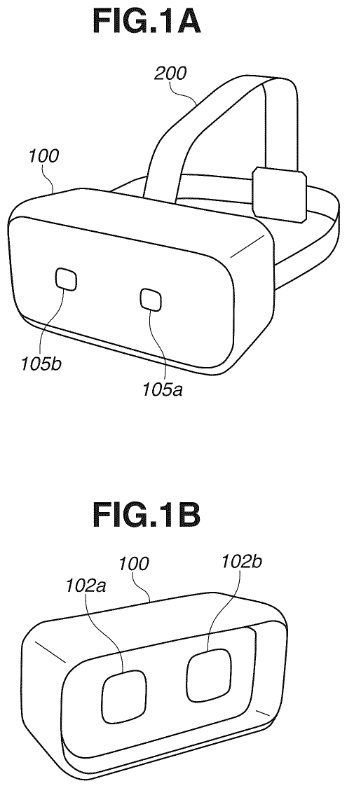

FIGS. 1A and 1B are perspective views illustrating an example of an appearance of an HMD 100 according to a first embodiment, in which FIG. 1A is a perspective view as seen from the front side of the HMD 100 and FIG. 1B is a perspective view as seen from the back side of the HMD 100. The HMD 100 is provided with a head band 200. The user applies the HMD 100 to the eye area of the user and fixes the HMD 100 to the head portion of the user with the head band 200.

The HMD 100 includes image capturing devices 105 (a left image capturing device 105a and a right image capturing device 105b). The left image capturing device 105a is a camera for capturing an external video image that is to be displayed on a left display (not illustrated in FIGS. 1A and 1B) located at a position corresponding to the left eye of the user. The right image capturing device 105b is a camera for capturing an external video image that is to be displayed on a right display (not illustrated FIGS. 1A and 1B) located at a position corresponding to the right eye of the user.

External video images captured by the image capturing devices 105 (105a and 105b) are displayed on the displays (display units), which are viewable through eyepiece units 102 (a left eyepiece unit 102a and a right eyepiece unit 102b), respectively. The external video image captured by the left image capturing device 105a is displayed on the left display, which is viewable through the left eyepiece unit 102a located at a position corresponding to the left eye of the user. The external video image captured by the right image capturing device 105b is displayed on the right display, which is viewable through the right eyepiece unit 102b located at a position corresponding to the right eye of the user.

The user is able to view the captured external video images, which are displayed on the displays located at the respective positions corresponding to the left eye and right eye of the user, by looking into the left eyepiece unit 102a and the right eyepiece unit 102b with the left eye and the right eye of the user, respectively.

### [Description of Block Diagram of HMD 100]

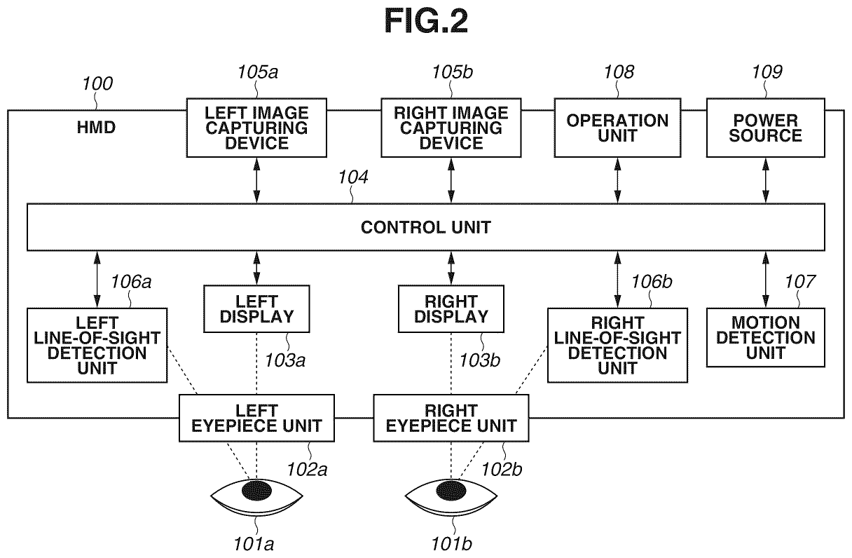

FIG. 2 is a block diagram illustrating an example of a configuration of the HMD 100 according to the first embodiment.

A control unit 104 includes a central processing unit (CPU), which serves as a computation unit, and memories such as a read-only memory (ROM), which stores a program executable by the CPU, and a random-access memory (RAM), which is used to store and read out various pieces of data, and controls the HMD 100. Additionally, the control unit 104 is able to perform control to superimpose a virtual object or a graphical user interface (GUI) (item) such as a pointer or a menu on a VR space and perform control to add a subject such as a character to an AR space.

Displays 103 (a left display 103a and a right display 103b), image capturing devices 105 (a left image capturing device 105a and a right image capturing device 105b), line-of-sight detection units 106 (a left line-of-sight detection unit 106a and a right line-of-sight detection unit 106b), a motion detection unit 107, an operation unit 108, and a power source 109 are connected to the control unit 104 via respective control lines.

The displays 103 (103a and 103b) display, on display devices such as liquid crystal displays (LCDs) or organic electroluminescence (EL) displays, external video images captured by the image capturing devices 105 (105a and 105b) according to signals received from the control unit 104. Specifically, the left display 103a displays an external video image captured by the left image capturing device 105a according to a signal received from the control unit 104, and the right display 103b displays an external video image captured by the right image capturing device 105b according to a signal received from the control unit 104.

Each of the image capturing devices 105 (105a and 105b) is a camera that captures an external video image and transmits the captured external video image to the control unit 104. Specifically, the image capturing devices 105 transmit, to the control unit 104, external video images respectively captured by the left image capturing device 105a and the right image capturing device 105b.

The line-of-sight detection units 106 (106a and 106b) are units that detect the lines of sight of the user who looks at the displays 103. In a case where the user wears the HMD 100 and looks at external video images, the user looks at the external video images via the displays 103 located inside the HMD 100. The lines of sight that are detected by the line-of-sight detection units 106 are merely lines of sight of the user who looks at the displays 103 and are not lines of sight of the user who looks at a subject in an external video image located at a position away from the displays 103 as seen from the user. Specifically, the left line-of-sight detection unit 106a detects the line of sight of the user the left eye 101a of whom looks at the left display 103a located inside the HMD 100 via the left eyepiece unit 102a. The right line-of-sight detection unit 106b detects the line of sight of the user the right eye 101b of whom looks at the right display 103b located inside the HMD 100 via the right eyepiece unit 102b.

In this way, the HMD 100 including the left line-of-sight detection unit 106a and the right line-of-sight detection unit 106b respectively corresponding to the left eye and right eye of the user enables accurately calculating the line-of-sight position of the user obtained when the user has looked at a subject in an external video image with both eyes, from detection results obtained from the respective line-of-sight detection units 106. Additionally, the HMD 100 being able to accurately calculate the line-of-sight position of the user obtained when the user has looked at a subject in an external video image with both eyes also enables increasing the accuracy in performing a predetermined processing operation based on the lines of sight. Specifically, even in a case where the image capturing devices 105 select a subject image in an external video image based on the lines of sight and then capture an image, the image capturing devices 105 are able to capture an image including a subject desired by the user. Additionally, even in the case of displaying a pointer indicating the line-of-sight position based on the lines of sight, it becomes possible to display the pointer at a position at which the user aims.

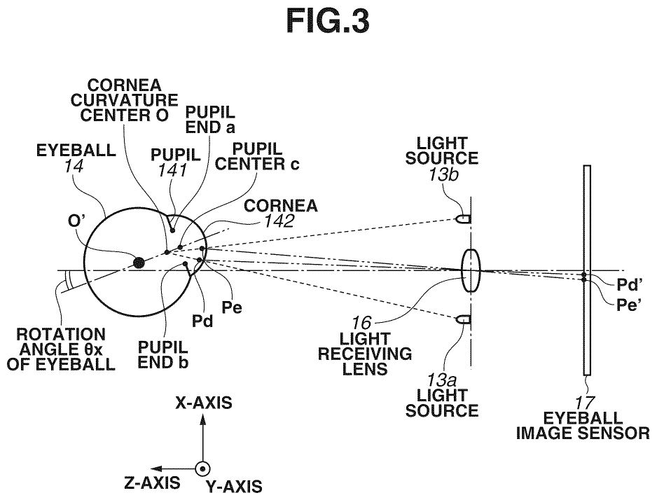

The internal configuration of each of the line-of-sight detection units 106 and line-of-sight detection processing operations that are performed by the line-of-sight detection units 106 are described below with reference to FIG. 3 to FIG. 5. Information about the line of sight of the user detected by each of the line-of-sight detection units 106 (for example, the line-of-sight position or line-of-sight direction) is transmitted to the control unit 104.

The motion detection unit 107 detects, for example, the amount of rotation, the direction of rotation, and the orientation of the HMD 100.

Motion information about, for example, the amount of rotation, the direction of rotation, and the orientation detected by the motion detection unit 107 is transmitted to the control unit 104. The motion detection unit 107 is configured to be able to detect the above-mentioned motion information, and is configured with, for example, a gyroscope sensor for detecting the rotation of the HMD 100 or a geomagnetic sensor for detecting the orientation of the HMD 100.

The operation unit 108 is a collective term for a plurality of input devices that are operable by the user (for example, buttons, switches, and dials). Upon detecting an operation performed on an input device, the control unit 104 performs a processing operation corresponding to the detected operation. Although, in the first embodiment, a configuration in which the HMD 100 includes the operation unit 108 is employed, an external device such as a controller wirelessly connected to the HMD 100 can include an operation unit that is capable of operating the HMD 100. In that case, upon detecting an operation on the operation unit included in the external device, the control unit 104 performs a processing operation corresponding to the detected operation.

Under the control of the control unit 104, the power source 109 supplies, to blocks including the displays 103, the image capturing devices 105, the line-of-sight detection units 106, the motion detection unit 107, and the operation unit 108, electric power required to control each of such blocks. The power source 109 is configured with a repeatedly chargeable and rechargeable battery. This battery can be a replaceable battery. Although, in the first embodiment, a configuration in which the HMD 100 includes the power source 109 is employed, the HMD 100 can be configured to receive electric power from an external device.

### [Description of Line-of-Sight Detection Processing]

Line-of-sight detection processing is described with reference to FIG. 3 to FIG. 5.

FIG. 3 is a diagram illustrating principles of line-of-sight detection. Illumination light sources 13a and 13b are arranged approximately symmetrically with respect to the optical axis of a light receiving lens 16 and radiate infrared light to an eyeball 14 of the user who looks in the HMD 100. The light receiving lens 16 forms, on an imaging plane of an eyeball image sensor 17, an eyeball image caused by infrared light reflected from the eyeball 14.

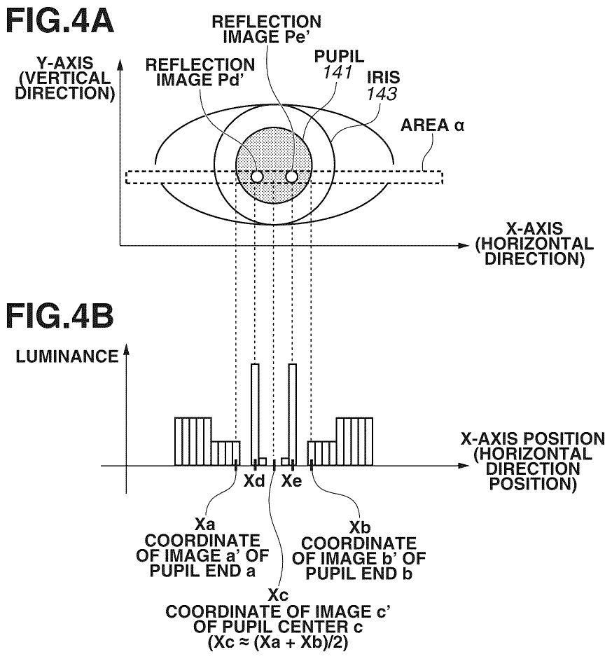

FIG. 4A is a schematic diagram of an eyeball image that the light-receiving lens 16 forms, and FIG. 4B is a schematic diagram of a luminance distribution in an area a illustrated in FIG. 4A.

Each of the left line-of-sight detection unit 106a and the right line-of-sight detection unit 106b includes the illumination light sources 13a and 13b, the light receiving lens 16, and the eyeball image sensor 17 each illustrated in FIG. 3, and performs line-of-sight detection processing for the user as described below.

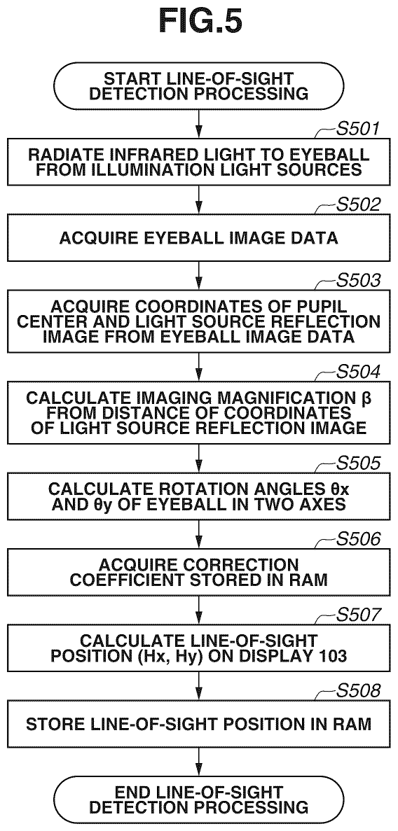

FIG. 5 is a flowchart concerning line-of-sight detection processing according to the first embodiment. The line-of-sight detection processing is processing that is performed by each of the left line-of-sight detection unit 106a and the right line-of-sight detection unit 106b, which correspond to the left eye and right eye of the user, respectively. The line-of-sight detection processing is able to be performed when, for example, it is detected that objects (eyes) are in proximity to the eyepiece units 102. A known optional method, such as a method of using proximity sensors provided in the vicinity of the eyepiece units 102, can be used to detect that objects (eyes) are in proximity to the eyepiece units 102. The line-of-sight detection processing can be started in response to an instruction issued by the user via the operation unit 108. The processing illustrated in the flowchart of FIG. 5 is performed by the control unit 104 controlling each unit. Moreover, the processing illustrated in the flowchart of FIG. 5 is repeatedly performed in response to an instruction received from the control unit 104.

In step S501, the control unit 104 causes an illumination light source driving circuit (not illustrated) to turn on the illumination light sources 13a and 13b for light emission. This causes infrared light to be radiated from the illumination light sources 13a and 13b toward the outside of the HMD 100. The infrared light is reflected from the eyeballs of the user who looks in the eyepiece units 102 and then enters the light receiving lens 16.

In step S502, the control unit 104 causes the eyeball image sensor 17 to perform image capturing. The eyeball image sensor 17 converts an eyeball image formed by the light receiving lens 16 into an image signal. The image signal is subjected to analog-to-digital (A/D) conversion by a line-of-sight detection circuit (not illustrated) and is then input as eyeball image data to the control unit 104.

In step S503, the control unit 104 obtains, from the eyeball image data acquired in step S502, the coordinates of cornea reflection images Pd′ and Pe′ of the illumination light sources 13a and 13b and the coordinates of an image c′ of the pupil center c. The eyeball image that is obtained by the eyeball image sensor 17 includes reflection images Pd′ and Pe′ corresponding to images Pd and Pe of the illumination light sources 13a and 13b appearing on the cornea 142, as illustrated in FIG. 3 and FIG. 4A.

As illustrated in FIG. 4A, the horizontal direction is set as an X-axis, and the vertical direction is set as a Y-axis. At this time, the X-axis coordinates of the centers of the reflection images Pd′ and Pe′ of the illumination light sources 13a and 13b included in the eyeball image are denoted as Xd and Xe, respectively. Moreover, the X-axis coordinates of images a′ and b′ of pupil ends a and b, which are the end portions of the pupil 141, are denoted as Xa and Xb, respectively.

As illustrated in FIG. 4B, the luminance values at the coordinates Xd and Xe corresponding to the reflection images Pd′ and Pe′ of the illumination light sources 13a and 13b are much higher than the luminance values at the other positions. On the other hand, the luminance values in the range between the coordinate Xa and the coordinate Xb, which corresponds to the area of the pupil 141, are very low except for those at the coordinates Xd and Xe. Moreover, the luminance values in the range of coordinates smaller than the coordinate Xa and the range of coordinates larger than the coordinate Xb, which correspond to the iris 143 outside the pupil 141, are intermediate between the luminance values of the reflection images Pd′ and Pe′ of the illumination light sources 13a and 13b and the remaining luminance values of the pupil 141.

Based on such characteristics of the luminance level in the X-axis direction, the control unit 104 is able to detect, from the eyeball image, the X-axis coordinates Xd and Xe of the reflection images Pd′ and Pe′ of the illumination light sources 13a and 13b and the X-axis coordinates Xa and Xb of the images a′ and b′ of the pupil ends a and b, respectively. Moreover, in an application use such as that in the first embodiment, the rotation angle θx of the optical axis of the eyeball 14 with respect to the optical axis of the light receiving lens 16 is relatively small. In such a case, the X-axis coordinate Xc of the image c′ of the pupil center c in the eyeball is able to be expressed as “Xc≈(Xa+Xb)/2”. In this way, the control unit 104 is able to obtain, from the eyeball image, the X-axis coordinates of the reflection images Pd′ and Pe′ of the illumination light sources 13a and 13b and the X-axis coordinate of the image c′ of the pupil center c. Although, in FIG. 3 and FIGS. 4A and 4B, the example of the control unit 104 obtaining X-axis coordinates has been illustrated, the control unit 104 is also able to obtain the corresponding Y-axis coordinates in a similar way.

In step S504, the control unit 104 calculates the imaging magnification β of the eyeball image. The imaging magnification β is a magnification that is determined by the position of the eyeball 14 relative to the light receiving lens 16, and is able to be obtained as a function of the interval (Xd−Xe) of the reflection images Pd′ and Pe′ of the illumination light sources 13a and 13b.

In step S505, the control unit 104 calculates the rotation angle of the eyeball. The X-axis coordinate of the midpoint between the images Pd and Pe of the illumination light sources 13a and 13b appearing on the cornea 142 and the X-axis coordinate of the curvature center O of the cornea 142 almost coincide with each other. Therefore, when the standard distance between the curvature center O of the cornea 142 and the center c of the pupil 141 is denoted as Oc, the rotation angle θx within a Z-X plane of the optical axis of the eyeball 14 is able to be obtained from a relational expression of “β×Oc×sin θx≈{(Xd+Xe)/2}−Xc”.

Although, in FIG. 3 and FIGS. 4A and 4B, the example of calculating the rotation angle θx in a plane perpendicular to the Y-axis is illustrated, the rotation angle θy in a plane perpendicular to the X-axis is also able to be calculated in a similar way. In this way, the control unit 104 obtains the rotation angles θx and θy of the eyeball. The control unit 104 is able to calculate the line-of-sight position from the rotation angles of the eyeball.

In step S506, the control unit 104 acquires correction coefficients from the RAM. The correction coefficient is a coefficient for correcting an individual difference of the line of sight of the user. The correction coefficient is generated by a calibration operation and is then stored in the RAM before starting the line-of-sight detection processing. In a case where the RAM stores correction coefficients for a plurality of users, the control unit 104 uses a correction coefficient associated with the current user by, for example, inquiring of, for example, the user at optional timing.

In step S507, the control unit 104 calculates the line-of-sight coordinates (line-of-sight position) of the user on the displays 103 with use of the rotation angles θx and θy of the eyeball calculated in step S505. Moreover, the control unit 104 determines that the line-of-sight position of the user is the coordinates (Hx, Hy) corresponding to the center c of the pupil 141 on the display 103 and is thus able to calculate the line-of-sight position of the user from expressions of “Hx=m×(Ax×θx+Bx)” and “Hy=m×(Ay×θy+By)”.

Here, the coefficient m is a conversion coefficient for converting the rotation angles θx and θy into coordinates corresponding to the center c of the pupil 141 on the displays 103 and is determined by the characteristics of the eyepiece units 102. The coefficient m can be preliminarily stored in the RAM. Moreover, the coefficients Ax, Bx, Ay, and By are the correction coefficients acquired in step S506.

In step S508, the control unit 104 records, in the RAM, the line-of-sight position and the time at which the image signal converted in step S502 has been acquired (the line-of-sight detection time), and then ends the line-of-sight detection processing.

After the line-of-sight position is detected and is then stored in the RAM in the above-described way, the control unit 104 performs predetermined processing based on information about the line-of-sight position stored in the RAM. Specifically, the predetermined processing is processing for displaying a pointer indicating the line-of-sight position or processing for selecting a subject located at the line-of-sight position.

[Method of Calculating Line-of-Sight Position Obtained when User has Looked at Video Image with Both Eyes from Line-of-Sight Positions of Left Eye and Right Eye]

The HMD 100 including the left line-of-sight detection unit 106a and the right line-of-sight detection unit 106b corresponding to the left eye and right eye of the user, respectively, enables accurately calculating the line-of-sight position of the user obtained when the user has looked at a subject in an external video image with both eyes, from the detection results obtained from the respective line-of-sight detection units 106.

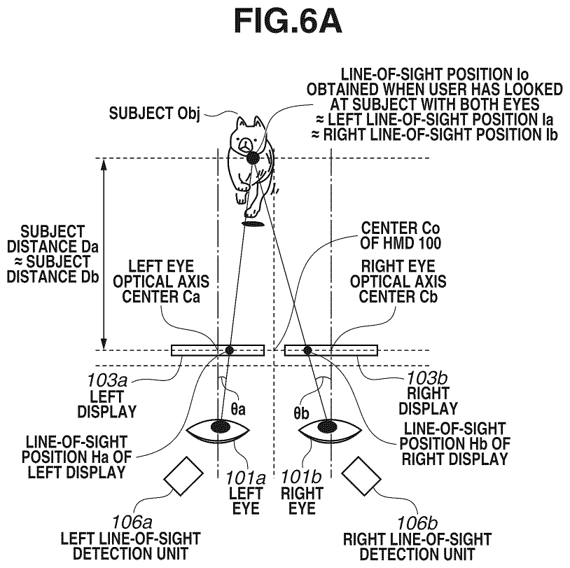

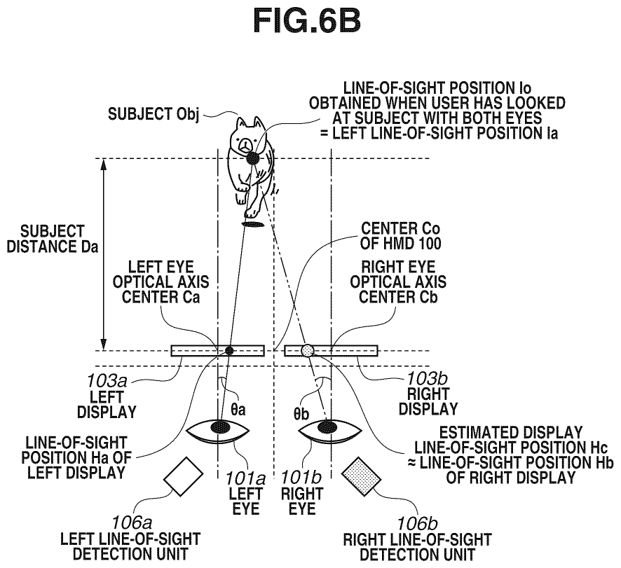

Specifically, the method of calculating the line-of-sight position obtained when the user has looked at a subject image with both eyes is described with reference to FIG. 6A.

FIG. 6A is a diagram illustrating a condition in which the left eye 101a and the right eye 101b of the user are looking at a subject Obj (dog) present in an AR space through the left display 103a and the right display 103b. At this time, the left line-of-sight detection unit 106a detects the line of sight of the left eye 101a, and the right line-of-sight detection unit 106b detects the line of sight of the right eye 101b.

The coordinates (Hax, Hay) of the line-of-sight position Ha of the left eye 101a of the user looking at the left display 103a is able to be calculated by the line-of-sight detection processing illustrated in FIG. 5. The left eye optical axis center in the left display 103a is denoted as Ca. Moreover, the coordinates (Hbx, Hby) of the line-of-sight position Hb of the right eye 101b of the user looking at the right display 103b is able to be calculated by the line-of-sight detection processing illustrated in FIG. 5. The right eye optical axis center in the right display 103b is denoted as Cb.

Here, in a case where the distance to the subject Obj in an AR space is greater than or equal to a predetermined value with respect to the displays 103 of the HMD 100 that the user is wearing, it is necessary to calculate the line-of-sight position Io obtained when the user has looked at the subject Obj in an AR space with both eyes taking into consideration the distance between the HMD 100 and the subject Obj.

The distance Da between the left display 103a and the subject Obj and the distance Db between the right display 103b and the subject Obj are calculated based on the focal length of a lens included in the left image capturing device 105a and the focal length of a lens included in the right image capturing device 105b, respectively. The method of calculating the distance between the display 103 and the subject Obj can be a method of performing calculation based on output information received from a distance measuring sensor included in the HMD 100 or a method of performing estimation based on an external video image.

Furthermore, in a case where the distance to the subject Obj in an AR space is less than the predetermined value, the coordinates at which the left eye line-of-sight direction that is based on the line-of-sight position Ha of the left eye 101a of the user and the right eye line-of-sight direction that is based on the line-of-sight position Hb of the right eye 101b of the user intersect can be calculated as the line-of-sight position Io obtained when the user has looked at a subject with both eyes.

The coordinates (Iax, Iay, Iaz) of the left line-of-sight position Ia obtained when the user has looked at the subject Obj with both eyes, with the center Co of the HMD 100 as the origin serving as the reference for the coordinates, are calculated by the following formulae:

$$Iax = Hax \times Da \times α ax + Hax \times β ax \times γ ax ( α ax , β ax , and γ ax being conversion coefficients ) ;$$

$$Iay = Hay \times Da \times α ay + Hay \times β ay \times γ ay ( α ay , β ay , and γ ay being conversion coefficients ) ; and$$

$$Iaz = Da \times Ka ( Ka being a conversion coefficient ) .$$

Moreover, the coordinates (Ibx, Iby, Ibz) of the right line-of-sight position Ib obtained when the user has looked at the subject Obj with both eyes, with the center Co of the HMD 100 as the origin serving as the reference for the coordinates, are calculated by the following formulae:

$$Ibx = Hbx \times Db \times α bx + Hbx \times β bx \times γ bx ( α bx , β bx , and γ bx being conversion coefficients ) ;$$

$$Iby = Hby \times Db \times α by + Hby \times β by \times γ by ( α by , β by , and γ by being conversion coefficients ) ; and$$

$$Ibz = Db \times Kb ( Kb being a conversion coefficient ) .$$

Here, the coefficients αax, αay, βax, βay, γax, γay, αbx, αby, βbx, βby, γbx, and γby, which are conversion coefficients, are, specifically, the following coefficients.

These conversion coefficients are coefficients for calculating the X-coordinates and Y-coordinates of the left line-of-sight position Ia and right line-of-sight position Ib obtained when the user has looked at the subject Obj with both eyes, from the line-of-sight position Ha of the left display 103a and the line-of-sight position Hb of the right display 103b. Moreover, the coefficients Ka and Kb, which are conversion coefficients, are coefficients for calculating the Z-coordinates of the left line-of-sight position Ia and right line-of-sight position Ib obtained when the user has looked at the subject Obj with both eyes, from the subject distances Da and Db. These conversion coefficients are preliminarily determined based on, for example, the characteristics of optical systems of the eyepiece units 102, the characteristics (for example, focal lengths) of optical systems of the image capturing devices 105, the center Co of the HMD 100, the left eye optical axis center Ca, and the right eye optical axis center Cb, and are then stored in the RAM.

The control unit 104 sets the average values of the coordinates (Iax, Iay, Iaz) of the calculated left line-of-sight position Ia and the coordinates (Ibx, Iby, Ibz) of the calculated right line-of-sight position Ib as the line-of-sight position Io obtained when the user has looked at the subject Obj with both eyes. Then, the control unit 104 selects a subject based on the calculated line-of-sight position Io.

Furthermore, for example, in a case where any one of the left line-of-sight position Ia or right line-of-sight position Ib cannot be calculated or is low in reliability due to, for example, line-of-sight detection or subject distance calculation having failed, the control unit 104 can set the line-of-sight position which has been successfully calculated or the line-of-sight position which is high in reliability as the line-of-sight position Io obtained when the user has looked at a subject with both eyes. Moreover, in a case where the subject distance is infinity, the control unit 104 can set the coordinates at which the left and right line-of-sight directions intersect as the line-of-sight position Io obtained when the user has looked at the subject with both eyes.

[Method of Calculating Line-of-Sight Position Obtained when User has Looked at Video Image with Both Eyes from Line-of-Sight Position of any One of Left Eye or Right Eye]

However, as mentioned above, there is a case where the control unit 104 does not need to calculate the line-of-sight position from the line of sight of the left eye and the line of sight of the right eye calculated by the left line-of-sight detection unit 106a and the right line-of-sight detection unit 106b, respectively. Thus, there is a case where the control unit 104 can calculate the line-of-sight position based on the line of sight calculated by any one of the line-of-sight detection units 106 and then calculate, based on the calculated line-of-sight position, the line-of-sight position Io obtained when the user has looked at the subject Obj with both eyes.

It is assumed that the case where the distance between the left line-of-sight position Ia and right line-of-sight position Ib obtained when the user has looked at a subject with both eyes is less than or equal to a predetermined value, i.e., a predetermined condition is satisfied, is a case where the user is stably gazing at the same subject Obj with both eyes. Thus, it is assumed that the case where the left line-of-sight position Ia and right line-of-sight position Ib obtained when the user has looked at a subject with both eyes are almost the same is a case where the user is stably gazing at the same subject Obj with both eyes. If the user is stably gazing at the same subject Obj with both eyes, it is possible to calculate the line-of-sight position Io obtained when the user has looked at the subject Obj with both eyes, based on the line-of-sight position calculated from the line of sight detected by any one of the line-of-sight detection units 106. In this way, the control unit 104 determines whether a predetermined condition is satisfied based on the distance between the left and right line-of-sight positions, and, if the predetermined condition is satisfied, the control unit 104 is able to detect the line-of-sight position Io even if line-of-sight detection processing in one of the line-of-sight detection units 106 is stopped. Stopping line-of-sight detection processing in one of the line-of-sight detection units 106 enables reducing the power consumption of the HMD 100 while calculating the line-of-sight position Io obtained when the user has looked at the subject Obj with both eyes. One of the line-of-sight detection units 106 not needing to perform line-of-sight detection processing can include stopping an operation of one of the line-of-sight detection units 106 as mentioned above or slowing an operation cycle (line-of-sight detection cycle).

Furthermore, the distance between the left line-of-sight position Ia and right line-of-sight position Ib obtained when the user has looked at a subject with both eyes can be set to the average value of distances between the left line-of-sight positions Ia and right line-of-sight positions Ib of an optional number of frames. Additionally, the predetermined value is determined based on the amount of noise measured at the time of a line-of-sight calibration, so that the influence of an individual difference can be reduced.

The method of calculating the line-of-sight position Io obtained when the user has looked at the subject Obj with both eyes based on the line-of-sight position calculated from the line of sight detected by any one of the line-of-sight detection units 106 is described with reference to FIG. 6B. Here, in FIG. 6B, it is assumed that a main line-of-sight detection unit being the left line-of-sight detection unit 106a and a subsidiary line-of-sight detection unit being the right line-of-sight detection unit 106b are preliminarily set by the user.

The control unit 104 calculates the line-of-sight position Io obtained when the user has looked at a subject with both eyes, based on the line-of-sight position Ha of the user looking at the left display 103a calculated from the line of sight detected by the main, left, line-of-sight detection unit 106a. Thus, the control unit 104 sets the line-of-sight position Io obtained when the user has looked at a subject with both eyes equal to the left line-of-sight position Ia obtained when the user has looked at a subject with both eyes. The coordinates (Iax, Iay, Iaz) of the left line-of-sight position Ia are calculated by the following formulae:

$$Iax = Hax \times Da \times α ax + Hax \times β ax \times γ ax ( α ax , β ax , and γ ax being conversion coefficients ) ;$$

$$Iay = Hay \times Da \times α ay + Hay \times β ay \times γ ay ( α ay , β ay , and γ ay being conversion coefficients ) ; and$$

$$Iaz = Da \times Ka ( Ka being a conversion coefficient ) .$$

Here, the coefficients αax, αay, βax, βay, γax, and γay, which are conversion coefficients, are coefficients for calculating the X-coordinate and Y-coordinate of the left line-of-sight position Ia obtained when the user has looked at the subject Obj with both eyes, from the line-of-sight position Ha of the left display 103a. Moreover, the coefficient Ka, which is a conversion coefficient, is a coefficient for calculating the Z-coordinate of the left line-of-sight position Ia obtained when the user has looked at the subject Obj with both eyes, from the subject distance Da. These conversion coefficients are preliminarily determined based on, for example, the characteristics of the eyepiece units 102, the center Co of the HMD 100, the left eye optical axis center Ca, and the right eye optical axis center Cb, and are then stored in the RAM. The control unit 104 sets the thus-calculated coordinates (Iax, Iay) of the left line-of-sight position Ia as the coordinates (Iox, Ioy) of the line-of-sight position Io obtained when the user has looked at a subject with both eyes.

Moreover, if the user is stably gazing the same subject Obj with both eyes, the coordinates (Iox, Ioy) of the line-of-sight position Io can serve as the coordinates of the right line-of-sight position. Therefore, the control unit 104 is able to estimate the line-of-sight position Hc of the right display 103b from the coordinates of the right line-of-sight position. The control unit 104 uses the estimated line-of-sight position Hc of the right display 103b for determining whether to continue power-saving mode as described below or for performing display of a pointer. The coordinates of the line-of-sight position Hc of the user looking at the right display 103b to be estimated are denoted as (Hcx, Hcy). The coordinates (Hcx, Hcy) are calculated from the following formulae:

$$Iox = Hcx \times Da \times α bx + Hcx \times β bx + γ bx ; and$$

$$Ioy = Hcy \times Da \times α by + Hcy \times β by + γ by .$$

Here, the coefficients αbx, αby, βbx, βby, γbx, and γby, which are conversion coefficients, are coefficients for calculating the X-coordinate and Y-coordinate of the right line-of-sight position Ib obtained when the user has looked at the subject Obj with both eyes, from the line-of-sight position Hb of the right display 103b. These conversion coefficients are preliminarily determined based on, for example, the characteristics of the eyepiece units 102, the center Co of the HMD 100, the left eye optical axis center Ca, and the right eye optical axis center Cb, and are then stored in the RAM.

The method of calculating the estimated line-of-sight position Hc of the user looking at the right display 103b is not limited to the above-described method. For example, the control unit 104 clips an image around the line-of-sight position Ha of the left display 103a of a video image displayed on the left display 103a and performs pattern matching between the clipped image and a video image displayed on the right display 103b. With this pattern matching, the control unit 104 can estimate the line-of-sight position Hc of the user looking at the right display 103b from a position with the highest correlation. Moreover, for example, in a case where the user is using the HMD 100 for viewing a two-dimensional (2D) video image, the control unit 104 can regard the coordinates of the line-of-sight position Ha of the left display 103a as the line-of-sight position Hc of the user looking at the right display 103b. In a case where, as in the first embodiment, the user looks at a deep subject in an external video image (3D space) with the left eye and the right eye, the line-of-sight positions of the left eye and the right eye looking at the subject may deviate from each other. Therefore, separately from the coordinates of the line-of-sight position Ha of the left display 103a, the control unit 104 estimates the line-of-sight position Hc of the user looking at the right display 103b.

In the first embodiment, the control unit 104 estimates the line-of-sight position Hc of the user looking at the right display 103b, based on the coordinates (Iax, Iay) of the left line-of-sight position Ia. However, although setting the left line-of-sight detection unit 106a as a main line-of-sight detection unit and setting the right line-of-sight detection unit 106b as a subsidiary line-of-sight detection unit, the control unit 104 can estimate the line-of-sight position of the user looking at the left display 103a, based on the coordinates (Ibx, Iby) of the right line-of-sight position Ib.

In this way, in a case where the user is stably gazing at the same subject Obj with both eyes, even if using only the line of sight detected by any one of the line-of-sight detection units 106, it is possible to reduce the power consumption of the HMD 100 without decreasing the accuracy in performing predetermined processing based on the line of sight.

In the above description, it has been explained that, in calculating the line-of-sight position obtained when the user has looked at a video image with both eyes, there is a case of using lines of sight detected by both of the line-of-sight detection units 106 and a case of using a line of sight detected by any one of the line-of-sight detection units 106.

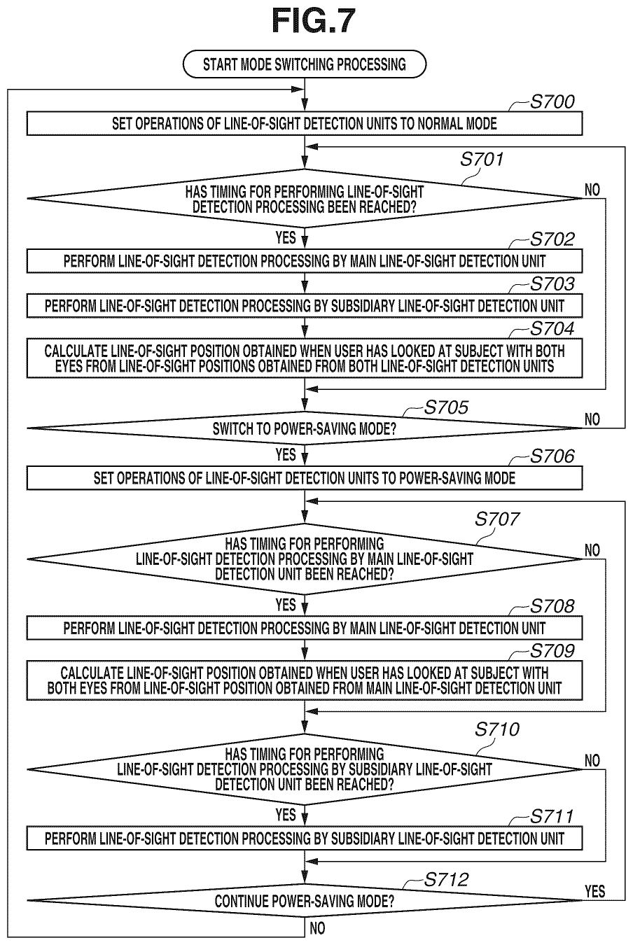

Next, upon referring to the case of using lines of sight detected by both of the line-of-sight detection units 106 as a normal mode and referring to the case of using a line of sight detected by any one of the line-of-sight detection units 106 as a power-saving mode, mode switching processing for switching between the normal mode and the power-saving mode is described. FIG. 7 is a flowchart concerning the mode switching processing according to the first embodiment, and the processing illustrated in FIG. 7 is started in response to the HMD 100 being started up and a video image being displayed on the displays 103. In FIG. 7, the left line-of-sight detection unit 106a is set as a main line-of-sight detection unit and the right line-of-sight detection unit 106b is set as a subsidiary line-of-sight detection unit.

In step S700, the control unit 104 sets operations of the line-of-sight detection units 106 to the normal mode. Thus, the control unit 104 sets the line-of-sight detection cycles of the left line-of-sight detection unit 106a and the right line-of-sight detection unit 106b to the same line-of-sight detection cycle (hereinafter referred to as a “normal detection cycle”). Then, the control unit 104 calculates the line-of-sight position obtained when the user has looked at a subject in an external video image with both eyes, with use of the lines of sight detected by both of the line-of-sight detection units 106. Here, the state in which the line-of-sight detection units 106 detect the line of sight at the normal detection cycle is set as a “first state”.

In step S701, the control unit 104 determines whether the timing at which the left line-of-sight detection unit 106a and the right line-of-sight detection unit 106b perform the line-of-sight detection processing has been reached, based on the normal detection cycle set in step S700. Specifically, the control unit 104 determines whether the timing at which it has been detected that objects (eyes) are in proximity to the eyepiece units 102 has been reached. If it is determined that the timing for performing the line-of-sight detection processing has been reached (YES in step S701), the control unit 104 advances the processing to step S702, and, if not so (NO in step S701), the control unit 104 advances the processing to step S705.

In step S702, the control unit 104 performs line-of-sight detection processing by the main, left, line-of-sight detection unit 106a, which is preliminarily set by the user. The line-of-sight detection processing in step S702 is performed based on the processing illustrated in the flowchart of FIG. 5. Accordingly, the coordinates (Hax, Hay) of the line-of-sight position Ha of the left eye 101a of the user looking at the left display 103a are calculated (FIG. 6A).

In step S703, the control unit 104 performs line-of-sight detection processing by the subsidiary, right, line-of-sight detection unit 106b, which is preliminarily set by the user. The line-of-sight detection processing in step S703 is performed based on the processing illustrated in the flowchart of FIG. 5. Accordingly, the coordinates (Hbx, Hby) of the line-of-sight position Hb of the right eye 101b of the user looking at the right display 103b are calculated (FIG. 6A).

In step S704, the control unit 104 calculates, from the line-of-sight position Ha of the left eye 101a of the user and the line-of-sight position Hb of the right eye 101b of the user, the left line-of-sight position Ia, the right line-of-sight position Ib, and the line-of-sight position Io obtained when the user has looked at a subject in an external video image with both eyes (FIG. 6A).

In step S705, the control unit 104 determines whether to switch the operations of the line-of-sight detection units 106 from the normal mode to the power-saving mode. Specifically, in a case where the distance between the left line-of-sight position Ia and the right line-of-sight position Ib obtained when the user has looked at a subject with both eyes is less than or equal to a predetermined value, the control unit 104 determines that the user is stably gazing at the same subject Obj with both eye and thus performs switching from the normal mode to the power-saving mode. Thus, if it is determined to switch the operations of the line-of-sight detection units 106 from the normal mode to the power-saving mode (YES in step S705), the control unit 104 advances the processing to step S706, and, if not so (NO in step S705), the control unit 104 returns the processing to step S701.

In step S706, the control unit 104 sets the operations of the line-of-sight detection units 106 to the power-saving mode and then advances the processing to step S707. Because, if the power-saving mode is set, the line of sight detected by any one of the line-of-sight detection units 106 is used, both the left line-of-sight detection unit 106a and the right line-of-sight detection unit 106b do not need to be set to the normal detection cycle. In a case where the left line-of-sight detection unit 106a is set as the main line-of-sight detection unit 106 and the right line-of-sight detection unit 106b is set as the other, subsidiary, line-of-sight detection unit 106, the control unit 104 sets the left line-of-sight detection unit 106a to the normal detection cycle.

Then, the control unit 104 sets the right line-of-sight detection unit 106b to a detection cycle slower than the normal detection cycle (hereinafter referred to as a “power-saving detection cycle”). Here, if the state in which the line-of-sight detection unit 106 detects the line of sight at the power-saving detection cycle slower than the normal detection cycle is set as a “second state,” the right line-of-sight detection unit 106b is changed from the first state to the second state. Furthermore, the state in which the line-of-sight detection processing to be performed by the line-of-sight detection units 106 is stopped can be set as the second state.

In step S707, the control unit 104 determines whether the timing at which the main, left, line-of-sight detection unit 106a performs the line-of-sight detection processing has been reached, based on the normal detection cycle set in step S706. Specifically, the control unit 104 determines whether the timing at which it has been detected that objects (eyes) are in proximity to the eyepiece units 102 has been reached. If it is determined that the timing for performing the line-of-sight detection processing has been reached (YES in step S707), the control unit 104 advances the processing to step S708, and, if not so (NO in step S707), the control unit 104 advances the processing to step S710.

In step S708, the control unit 104 performs line-of-sight detection processing by the main, left, line-of-sight detection unit 106a. The line-of-sight detection processing in step S708 is performed based on the processing illustrated in the flowchart of FIG. 5. Accordingly, the coordinates (Hax, Hay) of the line-of-sight position Ha of the left eye 101a of the user looking at the left display 103a are calculated (FIG. 6B).

In step S709, the control unit 104 calculates, based on the line-of-sight position Ha of the user looking at the left display 103a calculated from the line of sight detected by the left line-of-sight detection unit 106a, the line-of-sight position Io obtained when the user has looked at a subject with both eyes (FIG. 6B). Additionally, the control unit 104 estimates, from the line-of-sight position Io obtained when the user has looked at a subject with both eyes, the coordinates (Hcx, Hcy) of the line-of-sight position Hc of the right eye 101b of the user looking at the right display 103b.

In step S710, the control unit 104 determines whether the timing at which the subsidiary, right, line-of-sight detection unit 106b performs the line-of-sight detection processing has been reached, based on the power-saving detection cycle set in step S706. Specifically, the control unit 104 determines whether the timing at which it has been detected that objects (eyes) are in proximity to the eyepiece units 102 has been reached. If it is determined that the timing for performing the line-of-sight detection processing has been reached (YES in step S710), the control unit 104 advances the processing to step S711, and, if not so (NO in step S710), the control unit 104 advances the processing to step S712.

In step S711, the control unit 104 performs line-of-sight detection processing by the subsidiary, right, line-of-sight detection unit 106b. The line-of-sight detection processing in step S711 is performed based on the processing illustrated in the flowchart of FIG. 5. Accordingly, the coordinates (Hbx, Hby) of the line-of-sight position Hb of the right eye 101b of the user looking at the right display 103b are calculated (FIG. 6B). In this way, even if the detection cycle slower than the normal detection cycle is used, performing the line-of-sight detection processing by the subsidiary line-of-sight detection unit enables comparing the line-of-sight position of the right eye 101b estimated in step S709 and the line-of-sight position of the right eye 101b actually detected in step S711 with each other. Then, such a comparison enables determining whether to continue the power-saving mode in step S712.

In step S712, the control unit 104 determines whether to continue the power-saving mode. If it is determined to continue the power-saving mode (YES in step S712), the control unit 104 returns the processing to step S707, and, if not so (NO in step S712), the control unit 104 returns the processing to step S700.

In a case where the distance between the estimated line-of-sight position of the right eye 101b and the actually detected line-of-sight position of the right eye 101b is larger than a predetermined value, the control unit 104 determines that the estimation accuracy of the line-of-sight position has become low and thus, without continuing the power-saving mode, performs switching to the normal mode. On the other hand, in a case where the distance between the estimated line-of-sight position of the right eye 101b and the actually detected line-of-sight position of the right eye 101b is less than or equal to the predetermined value, the control unit 104 determines that the estimation accuracy of the line-of-sight position has not become low and thus continues the power-saving mode.

### [Timing for Performing Predetermined Processing Based on Line-of-Sight in Each Mode]

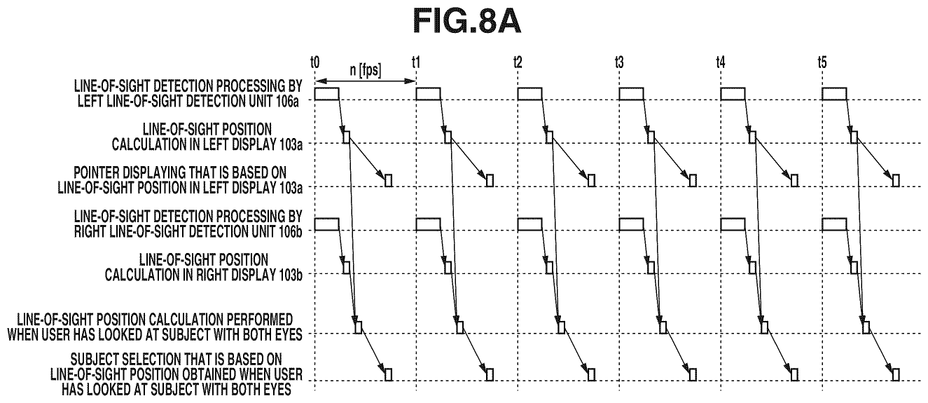

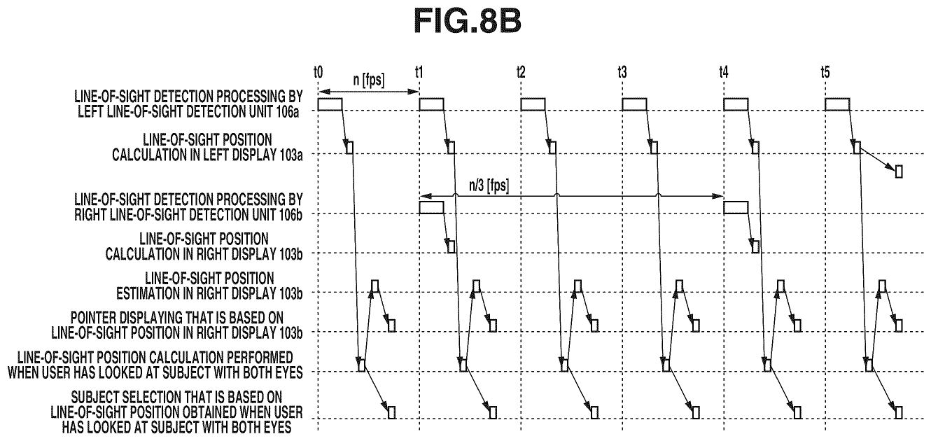

FIGS. 8A and 8B are diagrams illustrating timings at which to perform predetermined processing operations based on lines of sight in the respective modes, according to the first embodiment. In FIGS. 8A and 8B, the left line-of-sight detection unit 106a is set as a main line-of-sight detection unit and the right line-of-sight detection unit 106b is set as a subsidiary line-of-sight detection unit. However, the right line-of-sight detection unit 106b can be set as a main line-of-sight detection unit and the left line-of-sight detection unit 106a can be set as a subsidiary line-of-sight detection unit.

FIG. 8A is a diagram used to explain timings for performing predetermined processing operations based on the lines of sight in the normal mode. In the normal mode, the normal detection cycle in the left line-of-sight detection unit 106a and the right line-of-sight detection unit 106b is set to n frames per second (fps), and the vertical axes are set as times (t0 to t5). The horizontal axes represent, in order from the top, timing of line-of-sight detection processing by the left line-of-sight detection unit 106a, timing of line-of-sight position calculation in the left display 103a, and timing of pointer displaying that is based on the line-of-sight position in the left display 103a. Subsequently, the horizontal axes represent timing of line-of-sight detection processing by the right line-of-sight detection unit 106b and timing of line-of-sight position calculation in the right display 103b. Additionally, the horizontal axes represent timing of line-of-sight position calculation performed when the user has looked at a subject with both eyes and timing of subject selection that is based on the line-of-sight position obtained when the user has looked at a subject with both eyes.

In the above-described processing illustrated in FIG. 7, after performing line-of-sight detection processing by the main, left, line-of-sight detection unit 106a (step S702 illustrated in FIG. 7), the control unit 104 performs line-of-sight detection processing by the subsidiary, right, line-of-sight detection unit 106b (step S703 illustrated in FIG. 7). In the timings illustrated in FIG. 8A, the control unit 104 performs the line-of-sight detection processing by the main, left, line-of-sight detection unit 106a and the line-of-sight detection processing by the subsidiary, right, line-of-sight detection unit 106b at the same time. In this case, the timing for calculating the line-of-sight position in the left display 103a and the timing for calculating the line-of-sight position in the right display 103b also become the same. After that, the control unit 104 calculates the line-of-sight position obtained when the user has looked at a subject with both eyes, based on the line-of-sight positions in the respective displays 103. Additionally, after calculating the line-of-sight position obtained when the user has looked at a subject with both eyes, the control unit 104 performs pointer displaying based on the line-of-sight position in the left display 103a and, at the same time, performs subject selection based on the line-of-sight position obtained when the user has looked at a subject with both eyes. Furthermore, with regard to pointer displaying, the control unit 104 can perform pointer displaying based on the line-of-sight position in the right display 103b.

FIG. 8B is a diagram used to explain timings for performing predetermined processing operations based on the lines of sight in the power-saving mode. In the power-saving mode, the normal detection cycle in the left line-of-sight detection unit 106a is set to n (fps), the power-saving detection cycle in the right line-of-sight detection unit 106b is set to n/3 (fps), and the vertical axes are set as times (t0 to t5). The horizontal axes represent, in order from the top, timing of line-of-sight detection processing by the left line-of-sight detection unit 106a and timing of line-of-sight position calculation in the left display 103a. Subsequently, the horizontal axes represent timing of line-of-sight detection processing by the right line-of-sight detection unit 106b, timing of line-of-sight position calculation in the right display 103b, timing of line-of-sight position estimation in the right display 103b, and timing of pointer displaying that is based on the line-of-sight position in the right display 103b. Additionally, the horizontal axes represent timing of line-of-sight position calculation performed when the user has looked at a subject with both eyes and timing of subject selection that is based on the line-of-sight position obtained when the user has looked at a subject with both eyes.

At time t0, the control unit 104 starts line-of-sight detection processing by the left line-of-sight detection unit 106a and calculates the line-of-sight position in the left display 103a based on the detected line of sight. Then, the control unit 104 calculates the line-of-sight position obtained when the user has looked at a subject with both eyes, based on the line-of-sight position in the left display 103a, and then estimates the line-of-sight position in the right display 103b from the calculated line-of-sight position obtained when the user has looked at a subject with both eyes. Additionally, the control unit 104 performs pointer displaying based on the estimated line-of-sight position in the right display 103b and, at the same time, performs subject selection based on the line-of-sight position obtained when the user has looked at a subject with both eyes.

At time t1, the control unit 104 performs the line-of-sight detection processing by the left line-of-sight detection unit 106a and the line-of-sight detection processing by the right line-of-sight detection unit 106b at the same time. In this case, the timing for calculating the line-of-sight position in the left display 103a and the timing for calculating the line-of-sight position in the right display 103b also become the same. Here, the line-of-sight position in the right display 103b calculated based on the line of sight detected by the right line-of-sight detection unit 106b is used to determine whether to continue the power-saving mode.

Then, the control unit 104 calculates the line-of-sight position obtained when the user has looked at a subject with both eyes based on the line-of-sight position in the left display 103a, and then estimates the line-of-sight position in the right display 103b from the calculated line-of-sight position obtained when the user has looked at a subject with both eyes. Additionally, the control unit 104 performs pointer displaying based on the estimated line-of-sight position in the right display 103b and, at the same time, performs subject selection based on the line-of-sight position obtained when the user has looked at a subject with both eyes.

In the processing in the power-saving mode illustrated in FIG. 8B, the control unit 104 performs pointer displaying based on the estimated line-of-sight position in the right display 103b. In this case, performing pointer displaying based on the same line-of-sight position in the right display 103b even in the normal mode enables performing pointer displaying at a position which does not bring a feeling of strangeness, irrespective of the distance to a subject at which the user looks.

Furthermore, in the first embodiment, the power consumption of the electronic device is reduced by stopping the operation of any one of the line-of-sight detection units 106 or slowing the line-of-sight detection cycle. As another method, the power consumption of the electronic device can be reduced by, for example, decreasing the number of light sources to be turned on for light emission in the light sources included in each line-of-sight detection unit or controlling the intensity of light emission of each light source. Moreover, the power consumption of the electronic device can be reduced by, for example, decreasing the number of eyeball image sensors to be driven in the eyeball image sensors included in each line-of-sight detection unit or controlling, for example, the sensitivity of image capturing of each eyeball image sensor.

### Second Embodiment

In the above-described first embodiment, the main and subsidiary line-of-sight detection units 106 are preliminarily set by the user. A second embodiment enables switching between the main and subsidiary line-of-sight detection units 106 even after the main and subsidiary line-of-sight detection units 106 have been preliminarily set by the user. Specifically, the second embodiment enables switching between the main and subsidiary line-of-sight detection units 106 in conformity with features of the eyes of the user. This enables more accurately calculating the line-of-sight position obtained when the user has looked at a subject with both eyes.

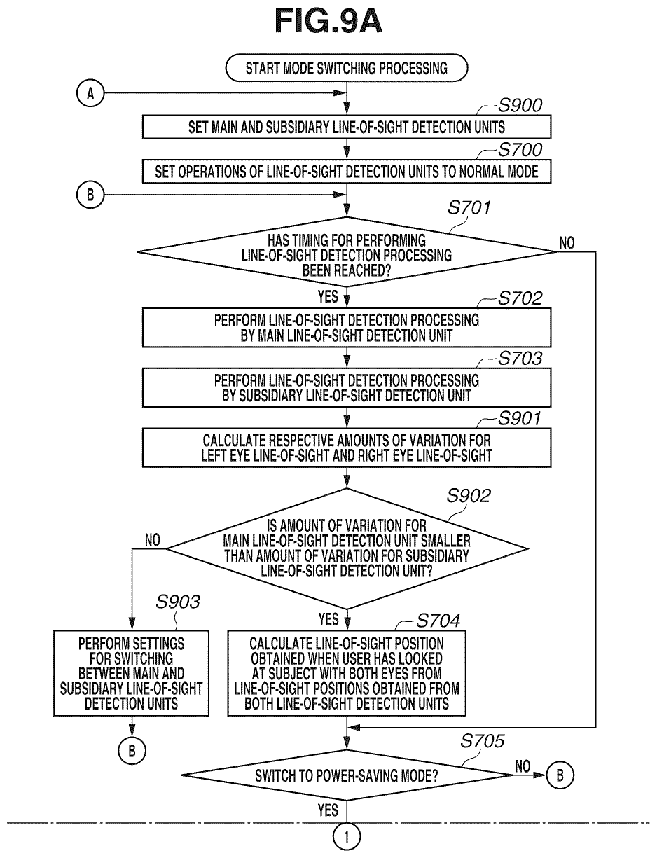

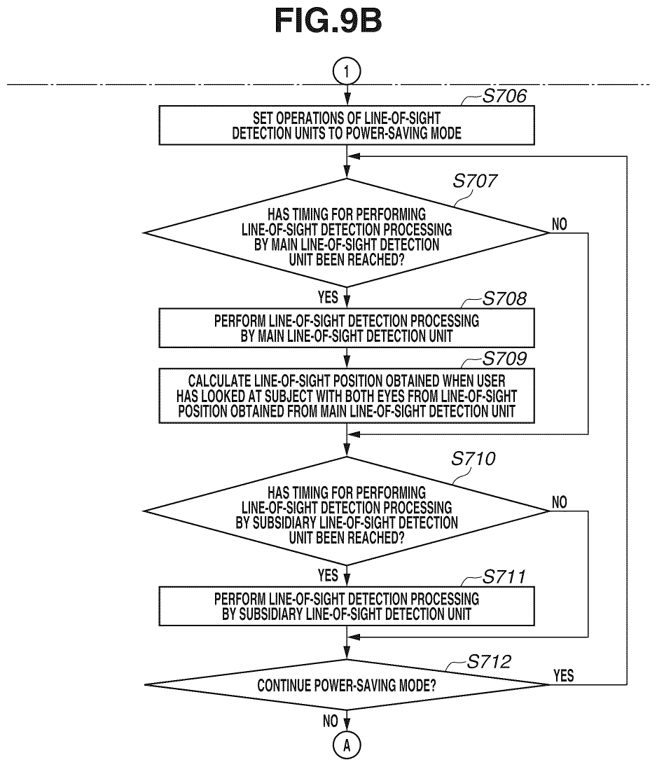

FIGS. 9A and 9B are flowcharts concerning mode switching processing according to the second embodiment, and, in the processing illustrated in the flowcharts of FIGS. 9A and 9B, steps S900, S901, S902, and S903, which do not overlap with the steps illustrated in the flowchart of FIG. 7, are described.

In step S900, the control unit 104 sets main and subsidiary line-of-sight detection units according to an instruction from the user. For example, the control unit 104 sets the left line-of-sight detection unit 106a as a main line-of-sight detection unit and sets the right line-of-sight detection unit 106b as a subsidiary line-of-sight detection unit. At the time of performing settings, the control unit 104 can set, as a main line-of-sight detection unit, a line-of-sight detection unit having a smaller amount of variation based on the amount of variation in calculating the correction coefficients Ax, Bx, Ay, and By in a calibration operation. The amount of variation is able to be calculated by summing differences (absolute values) of respective frames relative to the average value of line-of-sight positions for an optional number of frames at the time of calibration. Moreover, based on information about a preliminarily discriminated dominant eye, the control unit 104 can set a line-of-sight detection unit for the dominant eye as a main line-of-sight detection unit.

In step S901, the control unit 104 calculates the respective amounts of variation for the left eye and the right eye from line-of-sight information about the left eye detected by the left line-of-sight detection unit 106a and line-of-sight information about the right eye detected by the right line-of-sight detection unit 106b. While the amount of variation is able to be calculated by summing differences (absolute values) of respective frames relative to the average value of line-of-sight positions for an optional number of frames at the line-of-sight position of the user looking at the displays 103, the second embodiment is not limited to this calculation. For example, the control unit 104 can calculate the amount of variation based on the rotation angle θ in the line-of-sight direction.

In step S902, the control unit 104 compares the amount of variation for the left eye and the amount of variation for the right eye with each other, and, in a case where the left line-of-sight detection unit 106a is set as a main line-of-sight detection unit and the right line-of-sight detection unit 106b set as a subsidiary line-of-sight detection unit, if the amount of variation for the left eye is smaller than the amount of variation for the right eye (YES in step S902), while keeping the left line-of-sight detection unit 106a set as a main line-of-sight detection unit and the right line-of-sight detection unit 106b set as a subsidiary line-of-sight detection unit, the control unit 104 advances the processing to step S704. On the other hand, if the amount of variation for the left eye is larger than or equal to the amount of variation for the right eye (NO in step S902), the control unit 104 advances the processing to step S903.

In step S903, the control unit 104 performs settings for switching between main and subsidiary line-of-sight detection units. The control unit 104 performs settings for switching the main line-of-sight detection unit from the left line-of-sight detection unit 106a, as previously set by the user, to the right line-of-sight detection unit 106b, and switching the subsidiary line-of-sight detection unit from the right line-of-sight detection unit 106b, as previously set by the user, to the left line-of-sight detection unit 106a.

The above-described various control operations that have been described as operations to be performed by the control unit 104 (specifically, a CPU included therein) can be performed by a single piece of hardware, or control of the entire device can be performed by a plurality of pieces of hardware (for example, a plurality of processors or circuits) sharing the processing operations.

Moreover, while the present disclosure has been described in detail based on favorable embodiments thereof, the present disclosure is not limited to such specific embodiments, and various configurations that do not depart from the gist of the present disclosure are also included in the present disclosure. Additionally, the above-described embodiments are merely specific examples of the present disclosure, and some or all of the embodiments can be combined as appropriate.

According to an aspect of the present disclosure, it is possible to reduce the power consumption of an electronic device in the case of performing line-of-sight detection for the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-190707 filed Oct. 30, 2024, the entirety of which is incorporated herein by reference.

What is claimed is:

1. An electronic device comprising:
a first detection unit configured to detect a line of sight of a left eye of a user who looks at a first display unit;
a second detection unit configured to detect a line of sight of a right eye of the user who looks at a second display unit;
at least one memory storing a program; and
at least one processor that, upon execution of the stored program, is configured to:
in a case where a predetermined condition is satisfied, perform control to change any one of the first detection unit or the second detection unit from a first state to a second state that results in lower power consumption than the first state.

2. The electronic device according to claim 1, wherein the at least one processor, upon execution of the stored program is configured further to:
depending on whether the predetermined condition is satisfied or not, perform control to switch between a first mode and a second mode, and
in a case where the predetermined condition is not satisfied, in the first mode, calculate a line-of-sight position obtained when the user is looking at a subject displayed on the display units with both eyes, using a detection result obtained by the first detection unit and a detection result obtained by the second detection unit, and
in a case where the predetermined condition is satisfied, in the second mode, calculate the line-of-sight position obtained when the user is looking at the subject displayed on the display units with both eyes, using the detection result obtained by the detection unit other than the any one of the first detection unit or the second detection unit.

3. The electronic device according to claim 1, wherein the at least one processor, upon execution of the stored program, is configured further to:
detect a line-of-sight position of the left eye of the user in the first display unit based on the detection result obtained by the first detection unit and detect a line-of-sight position of the right eye of the user in the second display unit based on the detection result obtained by the second detection unit; and
determine whether the predetermined condition is satisfied, based on a distance between the detected line-of-sight position of the left eye of the user and the detected line-of-sight position of the right eye of the user.

4. The electronic device according to claim 1, wherein the at least one processor, upon execution of the stored program, is configured further to, in a case where the predetermined condition is not satisfied, perform control to bring both the first detection unit and the second detection unit into the first state.

5. The electronic device according to claim 1,
wherein the first state is a state in which a line of sight is detected based on a first detection cycle, and
wherein the second state is a state in which a line of sight is detected based on a second detection cycle slower than the first detection cycle.

6. The electronic device according to claim 3, wherein the at least one processor, upon execution of the stored program, is configured further to perform first processing at a position that is based on any one of the detected line-of-sight position of the left eye of the user or the detected line-of-sight position of the right eye of the user.

7. The electronic device according to claim 6, wherein the first processing is processing for displaying on the first display unit or the second display unit an item indicating a line-of-sight position.

8. The electronic device according to claim 2, wherein the at least one processor, upon execution of the stored program, is configured further to perform second processing at a position that is based on the calculated line-of-sight position obtained when the user is looking at the subject displayed on the display units with both eyes.

9. The electronic device according to claim 8, wherein the second processing is processing for selecting the subject.

10. A control method for an electronic device including a first detection unit configured to detect a line of sight of a left eye of a user who looks at a first display unit and a second detection unit configured to detect a line of sight of a right eye of the user who looks at a second display unit, the control method comprising:
in a case where a predetermined condition is satisfied, performing control to change any one of the first detection unit or the second detection unit from a first state to a second state that results in lower power consumption than the first state.

11. A non-transitory computer-readable storage medium storing computer-executable instructions that, when executed by a computer, cause the computer to perform a control method for an electronic device including a first detection unit configured to detect a line of sight of a left eye of a user who looks at a first display unit and a second detection unit configured to detect a line of sight of a right eye of the user who looks at a second display unit, the control method comprising:
in a case where a predetermined condition is satisfied, performing control to change any one of the first detection unit or the second detection unit from a first state to a second state that results in lower power consumption than the first state.
